(19) United States
(12) Patent Application Publication
(10) Pub. No.: US 2009/0148600 A1
(43) Pub. Date: Jun. 11, 2009

(54) Metal Nanoparticles Stabilized With a Carboxylic Acid-Organoamine Complex

(75) Inventors: Yuning LI, Mississauga (CA); Jonathan Siu-Chung LEE, Oakville (CA); Hualong PAN, Hamilton (CA); Paul F. SMITH, Oakville (CA); Hadi K. MAHABADI, Mississauga (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 11/950,450

(22) Filed: Dec. 5, 2007

(51) Int. Cl. B22F 9/24; B05D 5/00; B32B 5/16

(52) U.S. Cl. 427/256; 75/362; 428/403

(57) ABSTRACT

Metal nanoparticles with a stabilizer complex of a carboxylic acid-amine on a surface thereof is formed by reducing a metal carboxylate in the presence of an organoamine and a reducing agent compound. The metal carboxylate may include a carboxyl group having at least four carbon atoms, and the amine may include an organo group having from 1 to about 20 carbon atoms.

### BACKGROUND

Fabrication of electronic circuit elements using liquid deposition techniques is of profound interest as such techniques provide potentially low-cost alternatives to conventional mainstream amorphous silicon technologies for electronic applications such as thin film transistors (TFTs), light-emitting diodes (LEDs), RFID tags, photovoltaics, etc. However the deposition and/or patterning of functional electrodes, pixel pads, and conductive traces, lines and tracks which meet the conductivity, processing, and cost requirements for practical applications have been a great challenge.

Previous approaches utilizing conjugated polymers such polyaniline, carbon black pastes and metal pastes were beset with low conductivity, poor operational stability and high costs. Another approach utilizing organoamine stabilized silver nanoparticles did achieve a lower annealing temperature, as described in U.S. Pat. No. 7,270,694, which is incorporated by reference herein in its entirety.

Silver nanoparticles have also been prepared, for example as described in U.S. Pub. No. 0070099357 A1, incorporated by reference herein in its entirety, using 1) amine-stabilized silver nanoparticles and 2) exchanging the amine stabilizer with a carboxylic acid stabilizer. However, this method typically requires a carboxylic acid with a carbon chain length greater than 12 carbon atoms to afford sufficient solubility for solution-processing. Due to the high boiling point of such long-chain carboxylic acids and the strong bond between the carboxylic acid and silver nanoparticles, the annealing temperature required for obtaining conductive silver films is typically greater than 200° C. Although some specialty plastic substrates can withstand annealing temperatures of 250° C., most plastic substrates cannot and thus, dimensional stability is still an issue. Moreover, low cost plastic substrates favor an annealing temperature below 150° C.

### SUMMARY

There is therefore a need, addressed by the subject matter disclosed herein, for a method of preparing stable metal nanoparticle compositions that 1) can be printed on a low cost plastic substrate and annealed at a temperature below at least about 150° C. and 2) possess a sufficient shelf time.

The above and other issues are addressed by the present application, wherein in embodiments, the application relates to metal nanoparticles having a stabilizer attached to the surface of the nanoparticles, and to methods of producing the same. The nanoparticles may be stabilized using carboxylic acids and organoamines. The stabilized nanoparticles can be used to fabricate conductive elements having sufficiently high conductivity for electronic devices at a low temperature, for example, below about 200° C., or below about 150° C. The metal nanoparticles prepared in accordance with the present procedures possess, in embodiments, 1) good stability or shelf life and/or 2) low annealing temperatures, and may be made into metal nanoparticle compositions with suitable liquids for fabricating liquid-processed conductive elements for electronic devices.

The present application thus achieves advances over prior procedures for printing metal features on a substrate by forming a carboxylic acid-amine complex as a stabilizer on the surface of the metal nanoparticles. With appropriate selection of the metal carboxylate (at least 4 carbon atoms) and the organoamine (from about 1 to about 20 carbon atoms), the metal nanoparticles remain stable in solution and can be annealed into highly conductive thin metal films at temperatures of 200° C. or less, such as from about 80° C. to about 200° C., from about 100° C. to about 180° C., and, or from about 120° C. to about 150° C.

In embodiments, a method for producing metal nanoparticles comprises: reducing a metal carboxylate in the presence of an organoamine and a reducing agent, to form metal nanoparticles having a carboxylic acid-amine complex on the surface of the metal nanoparticles, wherein the metal carboxylate comprises a carboxyl group having at least four carbon atoms, and wherein the organoamine has from about 1 to about 20 carbon atoms.

In embodiments, a method for producing conductive metal features on a substrate comprises: dispersing the metal nanoparticles having a carboxylic acid-amine complex on the surface of the metal nanoparticles in a solvent to form a homogeneous solution; printing the homogeneous solution onto a substrate; and annealing the printed substrate to form metal features on the surface of the substrate.

In embodiments, described is a metal nanoparticle comprising a carboxylic acid-amine complex on the surface of the metal nanoparticle, wherein the carboxylic acid-amine complex is derived from a metal carboxylate including a carboxyl group having at least four carbon atoms and an organoamine having less than 20 carbon atoms, and thus where the complex includes a carboxyl group having at least four carbon atoms and an amine having less than 20 carbon atoms.

### EMBODIMENT

Thus, described herein is a method for making metal nanoparticles having a stabilizing complex on a surface thereof methods of making such metal nanoparticles, as well as the formation of metal features using such nanoparticles and a metal nanoparticle having a stabilizing complex on the surface thereof.

A method for producing the metal nanoparticles may be done by the reduction of a metal carboxylate (having at least four carbon atoms) in the presence of an organoamine and a hydrazine compound, to form metal nanoparticles with a carboxylic acid-amine complex on the surface of the metal nanoparticles. The method may isolate the metal nanoparticles with the molecules of the stabilizer on the surface of the metal nanoparticles. The metal nanoparticles may thereafter be dispersed into a solution to form a stabilized solution comprised of metal nanoparticles with molecules of the stabilizer on the surface of the metal nanoparticles.

The term “nano” as used in “metal nanoparticles” refers to, for example, a particle size of less than about 1,000 nm, such as, for example, from about 0.5 nm to about 1,000 nm, for example, from about 1 nm to about 500 nm, from about 1 nm to about 100 nm, or from about 1 nm to about 20 nm. The particle size refers to the average diameter of the metal particles, as determined by TEM (transmission electron microscopy) or other suitable method.

Chemical methods of making the metal nanoparticles with the stabilizer complex thereon may involve mixing a metal carboxylate salt with an initial stabilizer in an aqueous or non-aqueous medium with vigorous agitation, followed by the addition of a reducing agent.

In embodiments, the metal nanoparticles are composed of (i) one or more metals or (ii) one or more metal composites. Suitable metals may include, for examples Ag, Au, Pt, Pd, Cu, Co, Cr, In, and Ni, particularly the transition metals, for example, Ag, Au, Pt, Pd, Cu, Cr, Ni, and mixtures thereof. Silver may be used as a particularly suitable metal. Suitable metal composites may include Au—Ag, Ag—Cu, Au—Ag—Cu, and Au—Ag—Pd. The metal composites may include non-metals, such as, for example, Si, C, and Ge. The various components of the silver composite may be present in an amount ranging for example from about 0.01% to about 99.9% by weight, particularly from about 10% to about 90% by weight. In embodiments, the metal composite is a metal alloy composed of silver and one, two or more other Metals, with silver comprising for example at least about 20% of the nanoparticles by weight, particularly greater than about 50% of the nanoparticles by weight. Unless otherwise noted, the weight percentages recited herein for the components of the metal nanoparticles do not include the stabilizer.

In embodiments, the metal carboxylate contains, for example, from about 4 to about 20 carbon atoms, from about 4 to about 17 carbon atoms or from about 4 to about 12 carbon atoms. The metal carboxylate may include one or more than one carboxylic group. Further, the carboxylate may include heteroatoms, such as, for example, nitrogen, oxygen, sulfur, silicon, chlorine, bromine, iodine, fluorine, and the like. The metal carboxylate may be independently selected from, for example, metal butyrate, metal pentanoate, metal hexanoate, metal heptanoate, metal octanoate, metal nonanoate, metal decanoate, metal undecanoate, metal dodecanoate, metal tridecanoate, metal myristate, metal valerate, metal pentadecanoate, metal palmitate, metal heptadecanoate, metal stearate, metal oleate, metal nonadecanoate, metal icosanoate, metal eicosenoate, metal elaidate, metal linoleate metal pamitoleate and combinations thereof.

In embodiments, the organoamine contains, for example, from about 1 carbon atom to about 20 carbon atoms, from about 2 to about 18 carbon atoms, from about 4 to about 16 carbon atoms or from about 12 to about 16 carbon atoms. The term “organo” as used herein refers to the presence of carbon atoms, although the organo group may include heteroatoms such as, for example, nitrogen, oxygen, sulfur, phosphorus, silicon, fluorine, chlorine, bromine, iodine and the like. Further, the organo group may be linear, cyclic, branched and the like. Examples of suitable organoamines may include methylamine, ethylamine, propylamine, butylamine, pentylamine, hexylamine, heptylamine, octylamine, nonylamine, decylamine, hexadecylamine, undecylamine, dodecylamine, tridecylamine, tetradecylamine, dimethylamine, dipropylamine, dibutylamine, dipentylamine, dihexylamine, diheptylamine, dioctylamine, dinonylamine, didecylamine, or mixtures thereof.

In embodiments, the reducing agent compound may include a hydrazine compound. As used herein, the term “hydrazine compound” includes hydrazine (N₂N₄) and substituted hydrazines. The substituted hydrazines may include as substituting groups, for example, any suitable heteroatom such as S and O, and a hydrocarbon group having from, for example, about 0 to about 30 carbon atoms, from about 1 carbon atom to about 25 carbon atoms, from about 2 to about 20 carbon atoms or from about 2 to about 16 carbon atoms. The hydrazine compound may also include any suitable salts and hydrates of hydrazine such as, for example, hydrazine acid tartrate, hydrazine monohydrobromide, hydrazine monohydrochloride, hydrazine dichloride, hydrazine monooxalate, and hydrazine sulfate, and salts and hydrates of substituted hydrazines.

Examples of hydrazine compounds may include hydrocarbyl hydrazine, for example, RNHNH₂, RNHNHR′ and RR′NNH₂, where one nitrogen atom is mono- or di-substituted with R or R′, and the other nitrogen atom is optionally mono- or di-substituted with R, where each R or R′ is a hydrocarbon group. Examples of hydrocarbyl hydrazine include, for example, methylhydrazine, tert-butylhydrazine, 2-hydroxyethylhydrazine, benzylhydrazine, phenylhydrazine, tolylhydrazine, bromophenylhydrazine, chllorophenylhydrazine, nitrophenylhydrazine, 1,1-dimethylhydrazine, 1,1-diphenylhydrazine, 1,2-diethylhydrazine, and 1,2-diphenylhydrazine.

Unless otherwise indicated, in identifying the substituents for R and R′ of the various hydrazine compounds, the phrase “hydrocarbon group” encompasses both unsubstituted hydrocarbon groups and substituted hydrocarbon groups. Unsubstituted hydrocarbon groups may include any suitable substituent such as, for example, a hydrogen atom, a straight chain or branched alkyl group, a cycloalkyl group, an aryl group, an alkylaryl group, arylalkyl group or combinations thereof. Alkyl and cycloalkyl substituents may contain from about 1 to about 30 carbon atoms, from about 5 to 25 carbon atoms and from about 10 to 20 carbon atoms. Examples of alkyl and cycloalkyl substituents include, for example, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicosanyl, and combinations thereof. Aryl groups substituents may contain from about 6 to about 48 carbon atoms, from about 6 to about 36 carbon atoms, from about 6 to about 24 carbon atoms. Examples of aryl substituents include, for example, phenyl, methylphenyl(tolyl), ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl, or combinations thereof. Substituted hydrocarbon groups may be the unsubstituted hydrocarbon groups described herein which are substituted with one, two or more times with, for example, a halogen (chlorine, fluorine, bromine and iodine), a nitro group, a cyano group, an alkoxy group (methoxyl, ethoxyl and propoxy), or heteroaryls. Examples of heteroaryls groups may include thienyl, furanyl, pyridinyl, oxazoyl, pyrroyl, triazinyl, imidazoyl, pyrimidinyl, pyrazinyl, oxadiazoyl, pyrazoyl, triazoyl, thiazoyl, thiadiazoyl, quinolinyl, quinazolinyl, naphthyridinyl, carbazoyl, or combinations thereof.

Examples of hydrazine compounds may also include hydrocarbyl hydrazine salts (which is a salt of the hydrocarbyl hydrazine described herein) such as, for example, methylhydrazine hydrochloride, phenylhydrazine hydrochloride, benzylhydrazine oxalate, butylhydrazine hydrochloride, butylhydrazine oxalate salt, and propylhydrazine oxalate salt.

Examples of hydrazine compounds also include hydrazide, for example, RC(O)NHNH₂, RC(O)NHNHR′ and RC(O)NHNHC(O)R, where one or both nitrogen atoms are substituted by an acyl group of formula RC(O), where each R is independently selected from hydrogen and a hydrocarbon group, and one or both nitrogen atoms are optionally mono- or di-substituted with R′, where each R′ is an independently selected hydrocarbon group. Examples of hydrazide may include, for example, formic hydrazide, acetohydrazide, benzhydrazide, adipic acid dihydrazide, carbohydrazide, butanohydrazide, hexanoic hydrazide, octanoic hydrazide, oxamic acid hydrazide, maleic hydrazide, N-methylhydrazinecarboxamide, and semicarbazide.

Examples of hydrazine compounds may also include carbazates and hydrazinocarboxylates, for example, ROC(O)NHNHR′, ROC(O)NHNH₂ and ROC(O)NHNHC(O)OR, where one or both nitrogen atoms are substituted by an ester group of formula ROC(O), where each R is independently selected from hydrogen and a hydrocarbon group, and one or both nitrogen atoms are optionally mono- or di-substituted with R′, where each R′ is an independently selected hydrocarbon group. Examples of carbazate may include, for example, methyl carbazate (methyl hydrazinocarboxylate), ethyl carbazate, butyl carbazate, benzyl carbazate, and 2-hydroxyethyl carbazate.

Examples of hydrazine compounds may also include sulfonohydrazide, for example, RSO₂NHNH₂, RSO₂NHNHR′, and RSO₂NHNHSO₂R where one or both nitrogen atoms are substituted by a sulfonyl group of formula RSO₂, where each R is independently selected from hydrogen and a hydrocarbon group, and one or both nitrogen atoms are optionally mono- or di-substituted with R′, where each R′ is an independently selected hydrocarbon group. Examples of sulfonohydrazide may include, for example, methanesulfonohydrazide, benzenesulfonohydrazine, 2,4,6-trimethylbenzenesulfonohydrazidde, and p-toluenesulfonhydrazide.

Other hydrazine compounds may include, for example, aminoguanidine, tlhiosenmicarbazide, methyl hydrazinecarbimidothiolate, and thliocarbohydrazide.

One, two, three or more reducing agents may be used. In embodiments where two or more reducing agents are used, each reducing agent may be present at any suitable weight ratio or molar ratio such as, for example, from about 99(first reducing agent): 1(second reducing agent) to about 1(first reducing agent):99(second reducing agent).

The amount of reducing agent used includes, for example, from about 0.1 to about 10 molar equivalent per mole of metal compound, from about 0.25 to about 4 molar equivalent per mole of metal, or from about 0.5 to about 2 molar equivalent per mole of metal.

In embodiments, the metal carboxylate and the organoamine, in the presence of a hydrazine compound reducing agent, from a carboxylic acid-organoamine stabilizer on the surface of the metal nanoparticles. The carboxylic acids organoamine complex stabilizer may include from about 5 carbon atoms to about 40 carbon atoms, from about 16 carbon atoms to 36 carbon atoms and from about 18 carbon atoms to about 24 carbon atoms. The molar ratio of the metal carboxylate and the organoamine can be from about 0.1 to about 20, or from about 0.5 to about 10, or from about 1 to about 4.

The carboxylic acid-organoamine complex stabilizer may be formed on the surface of the nanoparticles by dissolving the metal carboxylate and the organoamine into a first solvent. The resulting solution may be optionally heated to a temperature, for example, from about 35° C. to about 150° C., from about 40° C. to about 100° C. or from about 45 (C to about 80° C., to increase the rate of dissolution.

Upon the addition of a hydrazine compound, in an optional second solvent, the resulting reaction mixture may be stirred, for example, from about one minute to about two hours, from about fifteen minutes to about 1 hour or from about twenty minutes to about forty minutes, and optionally heated to a temperature, for example, from about 35° C. to about 150° C., from about 40° C. to about 100° C. or from about 45° C. to about 80° C., thereby forming the stabilizer complex oil the surface of the metal nanoparticles. After optionally cooling the solution of metal nanoparticles containing carboxylic acid-organoamine complex stabilizer to room temperature, the metal nanoparticles may be collected from the solution by any suitable method. In one example, the nanoparticles may be collected by being precipitated from the solution by the use of a third solvent.

Any suitable solvent can be used for the first and second solvents, including, for example, organic solvents and/or water. The organic solvents include, for example, hydrocarbon solvents such as pentane, hexane, cyclohexane, heptane, octane, nonane, decane, undecane, dodecane, tridecane, tetradecane, toluene, xylene, mesitylene, and the like; alcohols such as methanol, ethanol, propanol, butanol, pentanol and the like, tetrahydrofuran; chlorobenzene; dichlorobenzene; trichlorobenzene; nitrobenzene; cyanobenzene; acetonitrile; dichloromethane; N,N-dimethylformamide (DMF); and mixtures thereof. One, two, three or more solvents may be used. In embodiments where two or more solvents are used, each solvent may be present at any suitable volume ratio or molar ratio such as for example from about 99(first solvent): 1(second solvent) to about 1 (first solvent:99(second solvent).

Any suitable solvent can be used for the third solvent. Examples may include any of the solvents detailed above including liquids that are mixable with the solvents which are used to disperse/solubilize the metal nanoparticles, but are non-solvents for the metal nanoparticles. Whether a particular liquid is considered a solvent or non-solvent can change depending on a number of factors including, for example, the polarity of the stabilizer and the size of the metal nanoparticles. In embodiments where two or more solvents are used, each solvent may be present at any suitable volume ratio or molar ratio such as for example from about 99(first solvent):1(second solvent) to about 1(first solvent):99(second solvent).

A variety of carboxylic acid-amine complex stabilizers may be formed which have the function of minimizing or preventing the metal nanoparticles from aggregation in a liquid and optionally providing the solubility or dispersibility of metal nanoparticles in a liquid. In addition, the carboxylic acid-amine complex stabilizer is connected to the surface of the metal nanoparticles and is not removed until the annealing of the metal nanoparticles during formation of metal features on a substrate.

In embodiments, the stabilizer complex is physically or chemically associated with the surface of the metal nanoparticles. In this way, the nanoparticles have the stabilizer thereon outside of a liquid system. That is, the nanoparticles with the stabilizer thereon, may be isolated and recovered from the reaction mixtures solution used in forming the nanoparticles and stabilizer complex. The stabilized nanoparticles may thus be subsequently readily and homogeneously dispersed in a liquid system for forming a printable solution.

As used herein, the phrase “physically or chemically associated” between the metal nanoparticles and the stabilizer can be a chemical bond and/or other physical attachment. The chemical bond can take the form of, for example, covalent bonding, hydrogen bonding, coordination complex bonding, or ionic bonding, or a mixture of different chemical bonds. The physical attachment can take the form of, for example, van der Waals' forces or dipole-dipole interaction, or a mixture of different physical attachments.

In embodiments, the metal nanoparticles may form a chemical bond with the stabilizer. The chemical names of the stabilizer provided herein are listed before the metal nanoparticles. If silver is the metal, examples include: pentanoic acid-butylamine silver nanoparticles, butyric acid-hexadecylamine silver nanoparticles, hexanoic acid-dodecylamine silver nanoparticles; valeric acid-hexadecyl amine silver nanoparticles, hexanoic acid-hexadecylamine silver nanoparticles, octanoic acid-dodecylamine silver nanoparticles and undecenoic acid-dodecylamine silver nanoparticles. The molar ratio of the carboxylic acid and the organoamine of the complex on the surface of metal nanoparticles may be, for example, from about 5 to about to 0.2, or from about 2 to about 0.5.

In embodiments, other organic stabilizers may be used in addition to the carboxylic acid-amine complex stabilizer. The term “organic” in “organic stabilizer” refers to, for example, the presence of carbon atom(s), but the organic stabilizer may include one or more non-metal heteroatoms such as nitrogen, oxygen, sulfur, silicon, halogen, and the like. Examples of other organic stabilizers include, for example, thiol and its derivatives, —OC(═S)SH (xanthic acid), polyethylene glycols, polyvinylpyridine, polyvinylpyrolidone, and other organic surfactants. The organic stabilizer may be selected from the group consisting of a thiol such as, for example, butanethiol, pentanethiol, hexanethiol, heptanethiol, octanethiol, decanethiol, and dodecanethiol; a dithiol such as, for example, 1,2-ethanedithiol, 1,3-propanedithiol, and 1,4-butanedithiol; or a mixture of a thiol and a dithiol. The organic stabilizer may be selected from the group consisting of a xanthic acid such as, for example, O-methylxanthate, O-ethylxanthate, O-propylxanthic acid, O-butylxanthic acid, O-pentylxanthic acid, O-hexylxanthic acid, O-heptylxantllic acid, O-octylxanthic acid, O-nonylxanthic acid, O-decylxanthic acid, O-undecylxanthic acid, O-dodecylxanthic acid. Organic stabilizers containing a pyridine derivative (for example, dodecyl pyridine) and/or organophosphine that can stabilize metal nanoparticles can also be used as a potential stabilizer.

One, two, three or more additional stabilizers other than organoamine may be used during the synthesis of the metal nanoparticles. In embodiments where one, two or more additional stabilizers are used, the additional stabilizer(s) other than organoamine may be present at any suitable weight ratio against organoamine such as, for example, from about 99(additional stabilizer(s)):1(organoamine) to about 1(additional stabilizer(s)):99(organoamine).

The extent of the coverage of stabilizer on the surface of the metal nanoparticles can vary, for example, from partial to full coverage depending on the capability of the stabilizer to stabilize the metal nanoparticles. Of course, there is variability as well in the extent of coverage of the stabilizer among the individual metal nanoparticles.

The carboxylic acid-amine complex stabilized metal nanoparticles may be dispersed in any suitable dispersing solvent in forming a solution that may be used to print and form metal features on a substrate. The weight percentage of carboxylic acid-amine complex stabilized metal nanoparticles in the dispersed solution may be from, for example, about 5 weight percent to about 80 weight percent, from about 10 weight percent to about 60 weight percent or from about 15 weight percent to about 50 weight percent. Examples of the dispersing solvent may include, for example, water, pentane, hexane, cyclohexane, heptane, octane, nonane, decane, undecane, dodecane, tridecane, tetradecane, toluene, xylene, mesitylene, and the like; alcohols such as, for example, methanol, ethanol, propanol, butanol, pentanol, hexanol, heptanol, octanol, and the like; tetrahydrofuran; chlorobenzene; dichlorobenzene; trichlorobenzene; nitrobenzene; cyanobenzene; acetonitrile; dichloromethane; N,N-dimethylformamide (DMF); and mixtures thereof. One, two, three or more solvents may be used. In embodiments where two or more solvents are used, each solvent may be present at any suitable volume ratio or molar ratio such as for example from about 99(first solvent):1(second solvent) to about 1(first solvent):99(second solvent).

If the metal is silver, the silver nanoparticles have a stability (that is, the time period where there is minimal precipitation or aggregation of the silver-containing nanoparticles) of for example, at least about 1 day, or from about 3 days to about 1 week, from about 5 days to about 1 month, from about 1 week to about 6 months, from about 1 week to over 1 year.

The resulting elements can be used as electrodes, conductive pads, thin-film transistors, conductive lines, conductive tracks, and the like in electronic devices such as thin film transistors, organic light emitting diodes, REED (radio frequency identification) tags, photovoltaic, and other electronic devices which require conductive elements or components.

The fabrication of an electrically conductive element from the metal nanoparticle composition (“composition”) can be carried out by depositing the composition, on a substrate using a liquid deposition technique at any suitable time prior to or subsequent to the formation of other optional layer or layers on the substrate. Thus, liquid deposition of the composition on the substrate can occur either on a substrate or on a substrate already containing layered material, for example, a semiconductor layer and/or an insulating layer.

The phrase “liquid deposition technique” refers to, for example, deposition of a composition using a liquid process such as liquid coating or printing, where the liquid is a solution or a dispersion. The metal nanoparticle composition may be referred to as an ink when printing is used. Examples of liquid coating processes may include, for example, spin coating, blade coating, rod coating, dip coating, and the like. Examples of printing techniques may include, for example, lithography or offset printing, gravure, flexography, screen printing, stencil printing, inkjet printing, stamping (such as microcontact printing), and the like. Liquid deposition deposits a layer of the composition having a thickness ranging from about 5 nanometers to about 5 millimeters, preferably from about 10 nanometers to about 1000 micrometers. The deposited metal nanoparticle composition at this stage may or may not exhibit appreciable electrical conductivity.

The stabilized metal nanoparticles can be spin-coated from the carboxylic acid-amine complex stabilized metal nanoparticles dispersed solution, for example, for about 10 seconds to about 1000 seconds, for about 50 seconds to about 500 seconds or from about 100 seconds to about 150 seconds, onto a substrate at a speed, for example, from about 100 revolutions per minute (“rpm”), to about 5000 rpm, from about 500 rpm to about 3000 rpm and from about 500 rpm to about 2000 rpm.

The substrate may be composed of, for example, silicon, glass plate, plastic film or sheet. For structurally flexible devices, plastic substrate, such as, for example, polyester, polycarbonate, polyimide sheets and the like may be used. The thickness of the substrate may be from amount 10 micrometers to about 10 millimeters, from about 50 micrometers to about 2 millimeters, especially for a flexible plastic substrate and from about 0.4 millimeters to about 10 millimeters for a rigid substrate such as glass or silicon.

Heating the deposited composition at a temperature of, for example, at or below about 200° C., at or below about 180° C., at or below about 170° C., or at or about below 150° C., induces the metal nanoparticles to form an electrically conductive layer, which is suitable for use as an electrically conductive element in electronic devices. The heating temperature is one that does not cause adverse changes in the properties of previously deposited layer(s) or the substrate (whether single layer substrate or multilayer substrate). Also, the low heating temperatures described above allows the use of low cost plastic substrates, which have an annealing temperature below 150° C.

The heating can be performed for a time ranging from, for example, about 1 second to about 10 hours and from about 10 seconds to about 1 hour. The heating can be performed in air, in an inert atmosphere, for example, under nitrogen or argon, or in a reducing atmosphere, for example, under nitrogen containing from about 1 to about 20 percent by volume hydrogen. The heating can also be performed under normal atmospheric pressure or at a reduced pressure of, for example, from about 1000 mbars to about 0.01 mbars.

As used herein, the term “heating” encompasses any technique(s) that can impart sufficient energy to the heated material to cause the desired result such as thermal heating (for example, a hot plate, an oven, and a burner), infra-red (“IR”) radiation, microwave radiation, or UV radiation, or a combination thereof.

Heating produces a number of effects. Prior to heating, the layer of the deposited metal nanoparticles may be electrically insulating or with very low electrical conductivity, but heating results in an electrically conductive layer composed of annealed metal nanoparticles, which increases the conductivity. In embodiments, the annealed metal nanoparticles may be coalesced or partially coalesced metal nanoparticles. In embodiments, it may be possible that in the annealed metal nanoparticles, the metal nanoparticles achieve sufficient particle-to-particle contact to form the electrically conductive layer without coalescence.

In embodiments, after heating, the resulting electrically conductive layer has a thickness ranging, for example, from about 5 nanometers to about 5 microns and from about 10 nanometers to about 2 microns.

The conductivity of the resulting conductive metal element produced by heating the deposited metal nanoparticle composition is, for example, more than about 0.1 Siemens/centimeter (“S/cm”), more than about 100 S/cm, more than about 500 S/cm, more than about 2,000 S/cm, more than about 5,000 S/cm, more than about 10,000 S/cm, and more than about 20,000 S/cm as measured by four-probe method.

In embodiments, the advantages of the present chemical method for preparing metal nanoparticles are one or more of the following: (i) single phase synthesis (where the silver compound, the stabilizer, and the solvent form a single phase) without the need for a surfactant; (ii) short reaction time; (iii) low reaction temperatures of below about 80° C. for the carboxylic acid-organoamine nanoparticle; (iv) stable metal nanoparticle composition which can be easily processed by liquid deposition techniques; (v) relatively inexpensive starting materials; (vi) low annealing temperature of below about 150° C. and (vii) suitable for large-scale production that would significantly lower the cost of metal nanoparticles.

In additional embodiments, there is provided an electronic device comprising in any suitable sequence:

a substrate;

an optional insulating layer or an optional semiconductor layer, or both the optional insulating layer and the optional semiconductor layer; and

an electrically conductive element of the electronic device, wherein the electrically conductive element comprises annealed metal nanoparticles, wherein the metal nanoparticles are a product of reacting a silver carboxylate compound and an organoamine compound with a reducing agent comprising a hydrazine compound to form metal nanoparticles with molecules of the stabilizer on the surface of the metal nanoparticles therein.

In more embodiments, there is provided a thin film transistor circuit comprising an array of thin film transistors including electrodes, connecting conductive lines and conductive pads, wherein the electrodes, the connecting conductive lines, or the conductive pads, or a combination of any two or all of the electrodes, the connecting conductive lines and the conductive pads comprise annealed metal nanoparticles, wherein the metal nanoparticles are a product of a reacting a stabilizer composed of metal carboxylate compound and an organoamine compound with a reducing agent comprising an hydrazine to form metal nanoparticles with molecules of the stabilizer on the surface of the metal nanoparticles.

The gate electrode, the source electrode, and the drain electrode are fabricated by present embodiments. The thickness of the gate electrode layer can be, for example, from about 10 to about 2000 nanometers. Typical thicknesses of source and drain electrodes can be, for example, from about 40 nanometers to about 2 microns with the more specific thickness being about 60 to about 400 nanometers.

The insulating layer generally can be an inorganic material film or an organic polymer film. Examples of inorganic materials that can be used as the insulating layer include silicon oxide, silicon nitride, aluminum oxide, barium titanate, barium zirconium titanate and the like; examples of organic polymers for the insulating layer include, for example, polyesters, polycarbonates, poly(vinyl phenol), polyimides, polystyrene, polymethacrylate)s poly(acrylate)s, epoxy resin and the like. The thickness of the insulating layer is, for example, from about 10 ml to about 500 nm depending on the dielectric constant of the dielectric material used or from about 100 nm to about 500 mm. The insulating layer may have a conductivity that is for example less than about 10⁻¹² S/cm.

Situated, for example, between and in contact with the insulating layer and the source/drain electrodes is the semiconductor layer wherein the thickness of the semiconductor layer is generally, for example, about 10 nm to about 1 micrometer, or about 40 to about 100 nm. Any semiconductor material may be used to form this layer. Exemplary semiconductor materials include regioregular polythiophene, oligthiophene, pentacene, and the semiconductor polymers disclosed in U.S. Publication No. 2003/0160230 A1; U.S. Publication No. 2003/0160234 A1; U.S. Publication No. US 2003/0136958 A1; the disclosures of which are totally incorporated herein by reference. Any suitable technique may be used to form the semiconductor layer. One such method is to apply a vacuum of about 10⁻⁵ to 10⁻⁷ torr to a chamber containing a substrate and a source vessel that holds the compound in powdered form. Heat the vessel until the compound sublimes onto the substrate. The semiconductor layer can also generally be fabricated by solution processes such as spin coating, casting, screen printing, stamping, or jet printing of a solution or dispersion of the semiconductor.

The insulating layer, the gate electrode, the semiconductor layer, the source electrode, and the drain electrode are formed in any sequence, particularly where in embodiments the gate electrode and the semiconductor layer both contact the insulating layer, and the source electrode and the drain electrode both contact the semiconductor layer. The phrase “in any sequence” includes sequential and simultaneous formation. For example, the source electrode and the drain electrode can be formed simultaneously or sequentially. The composition, fabrication, and operation of thin film transistors are described in Bao et al., U.S. Pat. No. 6,107,117, the disclosure of which is totally incorporated herein by reference

The embodiments disclosed herein will now be described in detail with respect to specific exemplary embodiments thereof, it being understood that these examples are intended to be illustrative only and the embodiments disclosed herein is not intended to be limited to the materials, conditions, or process parameters recited herein. All percentages and parts are by weight unless otherwise indicated. Room temperature refers to a temperature ranging for example from about 20 to about 25° C.

### Example 1

### Synthesis of Silver Butyrate

A sodium hydroxide solution (50 mL) was added to a butyric acid solution in methanol (50 mL). After stirring the mixture for 10 minutes, silver nitrate (9.86 g, 0.058 mol) in distilled water (50 mL) was added to form a white precipitate of silver propionate. After the precipitate was filtered, washed with distilled water and methanol, and dried in a vacuum, a white of silver butyrate (10 g) was obtained where percent yield from the preceding reaction is 90.7%.

Synthesis of Butyric Acid/Hexadecylamine-Stabilized Silver Nanoparticle

Silver butyrate (1.95 g, 10 mmol) and 1-hexadecylamine (6.04 g, 25 mmol) were dissolved in 20 mL of toluene by heating the mixture to 50° C. until the silver butyrate was fully dissolved. This dissolution occurred in about five minutes.

To this solution, a solution of phenylhydrazine (0.595 g, 5.5 mmol) in toluene (10 mL) was added and stirred for a period of five minutes. The resulting reaction mixture was stirred again at 50° C. for another 30 minutes before cooled to room temperature. Next, the mixture was added to a stirring methanol/acetone mixture (100 mL/100 ml) to precipitate the butyric acid-hexadecylamine-stabilized silver nanoparticle. Subsequently the precipitate was filtered, washed with a mixture of methanol and acetone (1/1, v/v) (3×50 mL), and air dried yielding butyric acid-hexadecylamine-stabilized silver nanoparticle product as dark grey semi-solid.

Preparation of Silver Nanoparticles Solution (Dispersion)

The butyric acid-hexadecylamine-stabilized silver nanoparticles were dissolved in toluene to form a dispersed homogeneous solution. The total weight of the solution was 4 grams and the concentration of element silver was 1.25 mmol/g. Next, the dispersed solution was filtered using a 0.2 micron PTFE (polytetrafluoroethylene, Teflon) or glass filter.

Fabrication and Annealing of Thin Films of Silver Nanoparticles

The above dispersed solution was spin-coated on a glass substrate at a speed of 1000 rpm for 120 seconds. Next, a hotplate in air heated the substrate with a thin layer of dark brown silver nanoparticles. A shiny silver film was then obtained after heating the substrate to a temperature of 140° C. for 25 minutes. The conductivity of the silver film was measured to be 3.0×10⁴ S/cm using a conventional four-probe technique.

### Examples 2-5

In Examples 2-5, the procedure used in Example 1 was followed, except that a different carboxylic acid was used in Example 2 (valeric acid), Example 3 (hexanoic acid), Example 4 (octanoic acid) and Example 5 (undecenoic acid). Also, Examples 4 and 5 used a different organoamine (dodecylamine).

TABLE 1
Properties of Silver Nanoparticles Prepared from Different
Silver Carboxylates and Organoamines.

| | | | Annealing | Conductivity | | |
|---|---|---|---|---|---|---|
| | | | Conditions | (× 10⁴, | Stability (days) | |
| Composition | Carboxylic Acid | Organoamine | (° C./25 min) | S/cm) | 25° C. | 0° C. |
| EXAMPLE 1 | Butyric Acid | Hexadecylamine | 140 | 3.0 | >7 | >30 |
| EXAMPLE 2 | Valeric Acid | Hexadecylamine | 140 | 3.0 | >7 | |
| EXAMPLE 3 | Hexanoic Acid | Hexadecylamine | 160 | 3.1 | >7 | |
| EXAMPLE 4 | Octanoic Acid | Dodecylamine | 180 | 2.9 | >7 | |
| EXAMPLE 5 | Undecenoic Acid | Dodecylamine | 180 | 3.0 | >7 | |
| Vacuum deposited | | | | 3.9 | | |
| Ag | | | | | | |

Table 1 shows that silver nanoparticles with various carboxylic acid-organoamine stabilizers are extremely stable for a period of seven to thirty days depending on the temperature and could be transformed to highly electrically conductive thin films upon annealing at 140° C.-180° C. for 25 minutes in air, with conductivity ranging from 2.9×10⁴ to 0.9×10⁴ S/cm.

### Comparative Example 1

Silver acetate (1.67 g, 11 mmol) and 1-hexadecylamine (6.04 g, 25 mmol) were dissolved in 20 mL of toluene by heating the mixture to 50° C. until the silver acetate was fully dissolved. This dissolution occurred in about five minutes. To this solution a solution of phenylhydrazine (0.595 g, 5.5 mmol) in toluene (5 mL) was added and stirred for a period of five minutes. The resulting reaction mixture was stirred again at 50° C. for another 30 minutes before being cooled to room temperature. Next, the mixture was added to a stifling methanol/acetone mixture (100 mL/100 mL) to precipitate the silver nanoparticles.

Subsequently, the precipitate was filtered, washed with a mixture of methanol and acetone (1/1, v/v) (3×50 mL), and air dried yielding silver nanoparticle product as dark grey semi-solid. The silver nanoparticles were dissolved in toluene to form a dispersed homogeneous solution. The total weight of the solution was 4 grams and the concentration of element silver was 1.25 mmol/g. Next, the dispersed solution was filtered using a 0.2 micron PTFE or glass filter. The solution was stored at room temperature in a glass vial and precipitation appeared after 3 days.

### Comparative Example 2

Silver acetate (3.34 g, 20 mmol) and oleylamine (13.4 g, 50 mmol) were dissolved in 40 mL toluene by heating the mixture to 55° C. for 5 minutes. A solution of phenylhydrazine (1.19 g, 11 mmol) in toluene (10 mL) was added with vigorous stirring. The resulting reaction mixture was stirred at 55° C. for an additional 10 minutes and added to a mixture of acetone/methanol (150 mL/150 mL) to precipitate the silver nanoparticles. The precipitate was then filtered and washed with an additional solution of acetone and methanol and dried in air.

The precipitate was then dissolved in 50 mL of hexane and added to a solution of oleic acid (14.12 g, 50 mmol) in hexane (50 mL) at room temperature. After 30 minutes, the hexane was removed and the residue poured into a stirred solution of methanol (300 mL). The precipitate was then filtered, washed with methanol, and dried in a vacuum to form a grey solid. The silver nanoparticles were dissolved in toluene to form a dispersed homogeneous solution. The total weight of the solution was 4 grams and the concentration of element silver was 1.25 mmol/g.

Next, the dispersed solution was filtered using a 0.2 micron PTFE or glass filter and spin-coated on a glass substrate at a speed of 1000 rpm for 120 seconds. The substrate, with a thin layer of dark brown silver nanoparticles, was heated on a hotplate in air. A shiny silver film was obtained after heating the substrate to 210° C., for 25 minutes. The conductivity of the silver film was measured to be 2.8×10⁴ S/cm using a conventional four-probe technique. Heating the substrate with silver nanoparticles at a temperature lower than 200° C. could not afford conductive silver thin films after heating for 30 minutes.

It will be appreciated that various of the above-disclosed and other features and functions, or alternatives thereof may be desirably combined into many other different systems or applications. Also, various presently unforeseen or unanticipated alternatives, modifications, variations or improvements therein may be subsequently made by those skilled in the art, and are also intended to be encompassed by the following claim.

What is claimed is:

1. A method for producing metal nanoparticles comprising:
reducing a metal carboxylate in the presence of an organoamine and a reducing agent compound to form metal nanoparticles having a carboxylic acid-amine complex on the surface of the metal nanoparticles,
wherein the metal carboxylate comprises a carboxyl group having at least four carbon atoms, and wherein the organoamine has from 1 to about 20 carbon atoms.

2. The method according to claim 1, wherein the metal nanoparticles are selected from the group consisting of silver, gold, platinum, palladium, copper, cobalt, chromium, nickel, silver-copper composite, silver-gold-copper composite, silver-gold-palladium composite and combinations thereof.

3. The method according to claim 1, wherein the metal nanoparticles are selected from a group consisting of silver, silver-copper composite, silver-gold-copper composite, silver-gold-palladium composite and combinations thereof.

4. The method according to claim 3, wherein the silver and silver composite nanoparticles have a stability of at least 7 days when dispersed in a solvent selected from the group consisting of water, pentane, hexane, cyclohexane, heptane, octane, nonane, decane, undecane, dodecane, tridecane, tetradecane, toluene, xylene, mesitylene, methanol, ethanol, propanol, butanol, pentanol, hexanol, heptanol, octanol, tetrahydrofuran, chlorobenzene, dichlorobenzene, trichlorobenzene, nitrobenzene, cyanobenzene, acetonitrile, dichloromethane, N,N-dimethylformamide (DMF), and combinations thereof.

5. The method according to claim 1, wherein the size of the metal nanoparticles is from about 0.5 nanometers to about 1000 nanometers.

6. The method according to claim 1, wherein the size of the metal nanoparticles is from about 1 nanometer to about 500 nanometers.

7. The method according to claim 1, wherein the metal carboxylate comprises a carboxyl group having from 4 carbon atoms to about 16 carbon atoms.

8. The method according to claim 1, wherein the organoamine comprises an organo group having from about 2 carbon atoms to about 18 carbon atoms.

9. The method according to claim 1, wherein the organoamine comprises methylamine, ethylamine, propylamine, butylamine, pentylamine, hexylamine, heptylamine, octylamine, nonylamine, decylamine, undecylamine, dodecylamine, tridecylamine, tetradecylamine, hexadecylamine, dimethylamine, dipropylamine, dibutylamine, dipentylamine, dihexylamine, diheptylamine, dioctylamine, or combinations thereof.

10. The method according to claim 1, wherein the carboxylic acid-amine complex includes from about 16 total carbon atoms to about 36 total carbon atoms.

11. The method according to claim 1, wherein the reducing agent is a hydrazine compound.

12. The method according to claim 11, wherein the hydrazine compound is one or more of (1) a hydrocarbyl hydrazine represented by the following formulas: RNHNH₂, RNHNHR′ or RR′NNH₂, wherein one nitrogen atom is mono- or di-substituted with R, and the other nitrogen atom is optionally mono- or di-substituted with R, wherein R is independently selected from a hydrogen or hydrocarbon group or mixtures thereof wherein one or both nitrogen atoms are optionally mono- or di-substituted with R′ and wherein R′ independently selected from a group consisting of hydrogen or hydrocarbon group or mixtures thereof, (2) a hydrazide represented by the following formulas: ROC(O)NHNHR′, ROC(O)NHNH₂ or ROC(O)NHNHC(O)OR, wherein one or both nitrogen atoms are substituted by an acyl group of formula RC(O), wherein each R is independently selected from a hydrogen or hydrocarbon group or mixtures thereof, wherein one or both nitrogen atoms are optionally mono- or di-substituted with R′ and wherein R′ independently selected from a group consisting of hydrogen or hydrocarbon group or mixtures thereof, and (3) a carbazate represented by the following formulas: ROC(O)NHNHR′, ROC(O)NHNH₂ or ROC(O)NHNHC(O)OR, wherein one or both nitrogen atoms are substituted by an ester group of formula ROC(O), wherein R is independently selected from a group consisting of hydrogen and a linear, branched, or aryl hydrocarbon, wherein one or both nitrogen atoms are optionally mono- or di-substituted with R′ and wherein R′ is independently selected from a group consisting of hydrogen or hydrocarbon group or mixtures thereof.

13. The method according to claim 1, wherein the metal carboxylate, organoamine and reducing agent are in solution.

14. The method according to claim 13, wherein the solution is heated to a temperature below about 100° C. for from about 2 minutes to about 1 hour.

15. A method for producing metal features on a substrate comprising:
dispersing metal nanoparticles of having a carboxylic acid-amine complex on the outer surface of the metal nanoparticles in a solvent to form a solution;
printing the solution onto a substrate; and
annealing the printed substrate to torn metal features on the surface of the substrate.

16. The method according to claim 15, wherein the annealing is conducted at a temperature of from about 100° C. to about 180° C.

17. The method according to claim 15, wherein the metal is silver or silver composite.

18. A metal nanoparticle comprising a carboxylic acid-amine complex on the surface of the metal nanoparticle, wherein the carboxylic acid-amine complex includes a carboxyl group having at least four carbon atoms and an amine having from 1 to about 20 carbon atoms.

19. The metal nanoparticle according to claim 1S, wherein the metal nanoparticle is selected from a group consisting of silver, silver-copper composite, silver-gold-copper composite, silver-gold-palladium composite and combinations thereof.

20. The metal nanoparticle according to claim 1S, wherein the metal nanoparticles are dispersed in a solvent to form a metal nanoparticle solution.

21. The metal nanoparticle according to claim 20, wherein the solvent for the metal nanoparticle solution is selected from the group consisting of water, pentane, hexane, cyclohexane, heptane, octane, nonane, decane, undecane, dodecane, tridecane, tetradecane, toluene, xylene, mesitylene, methanol, ethanol, propanol, butanol, pentanol, hexanol, heptanol, octanol, tetrahydrofuran, chlorobenzene, dichlorobenzene, trichlorobenzene, nitrobenzene, cyanobenzene, acetonitrile, dichloromethane, N,N-dimethylformamide (DMF), and combinations thereof.
